(19) United States
(12) Patent Application Publication
(10) Pub. No.: US 2023/0214943 A1
(43) Pub. Date: Jul. 6, 2023

(54) DINING GROUP INTEREST CONNECTION SYSTEM

(71) Applicant: Charles Isgar, Scottsdale, AZ (US)

(72) Inventor: Charles Isgar, Scottsdale, AZ (US)

(21) Appl. No.: 18/183,502

(22) Filed: Mar. 14, 2023

Related U.S. Application Data
(63) Continuation of application No. 16/232,835, filed on Dec. 26, 2018, now abandoned.
(60) Provisional application No. 62/608,434, filed on Dec. 20, 2017.

(51) Int. Cl. G06Q 50/12

(52) U.S. Cl. CPC G06Q 50/12

(57) ABSTRACT

A dining group interest connection system is provided. The system may operate by using stored host/expert and guest information to compensate hosts and connect hosts with guests for a meal and conversation regarding a shared field of interest. The host earns a compensation to make himself or herself available to guests for participating in a dining experience based on the knowledge, skill or the like in a field of interest.

### CROSS REFERENCE TO RELATED APPLICATION[S]

This application is a continuation of U.S. Patent Application entitled “DINNER GROUP CONNECTION SYSTEM,” Ser. No. 16/232,835, filed Dec. 26, 2018, which claims priority to U.S. Provisional Patent Application entitled “DINNER GROUP CONNECTION SYSTEM,” Ser. No. 62/608,434, filed Dec. 22, 2017, the disclosures of which are hereby incorporated entirely herein by reference.

### BACKGROUND OF THE INVENTION

### Technical Field

This invention relates to a dining group interest connection system and a method of using a dining group interest connection system using stored host/expert and guest information to compensate hosts and connect hosts with guests for a meal and conversation regarding a shared field of interest.

### State of the Art

Diners (groups, couples and/or individuals) are often looking for stimulating intellectual or entertaining conversation at a meal. Accordingly, an application that allows diners to match with hosts to provide conversation in a desired field of interest during dining at restaurants or at home is needed.

### SUMMARY OF EMBODIMENTS

Disclosed is a dining group interest connection system comprising: a server having a memory storing guest data, host data and an application that supplies programming to the server; and a guest computing device coupled to the server, wherein the server, through the stored application, is programmed to: receive a request for the guest computing device requesting a dining experience with a registered host and automatically access the stored guest data associated with a guest and host data to determine a match between the guest and a list of registered hosts; send for display on the guest computing device, the list of registered hosts, wherein a registered host of the list of registered hosts are selectable through the guest computing device; receive a selection of the registered host and a dining location from the guest computing device and automatically book a dining experience for the guest and the registered host; and send for display on the guest computing device, a confirmation of the dining experience.

Disclosed is a method of using a dining group interest connection system, the method comprising: receiving a request from a guest computing device by a server requesting a dining experience with a registered host and automatically access stored guest data associated with a guest using the guest computing device and host data; determining by the server a match between the guest and a list of registered hosts; displaying on the guest computing device, the list of registered hosts, wherein each registered host of the list of registered hosts are selectable through the guest computing device; receiving a selection of the registered host and a dining location from the guest computing device by the server; automatically book a dining experience for the guest and the registered host by the server; and displaying on the guest computing device, a confirmation of the dining experience.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a diagrammatic view of a dining group interest connection system in accordance with an embodiment;

FIG. 2 is a flow chart of programmed steps of a computer server of a dining group interest connection system in accordance with an embodiment;

FIG. 3A is a perspective view of a venue using the dining group interest connection system for a private dining experience in accordance with an embodiment;

FIG. 3B is a perspective view of a venue using the dining group interest connection system for an open dining experience in accordance with an embodiment;

FIG. 4A is a diagrammatic view of a dining group interest connection system operating is a venue host environment according to an embodiment;

FIG. 4B is a view of a guest computing device utilizing the dining group interest connection system operating in the venue host environment according to an embodiment;

FIG. 4C is a view of a guest computing device utilizing the dining group interest connection system operating in an online reservation system according to an embodiment; and

FIG. 5 is a view of a guest computing device accessing the dining group interest connection system utilizing proximity sensing to determine hosts/experts nearby in accordance with an embodiment.

### DETAILED DESCRIPTION OF EMBODIMENTS OF THE INVENTION

The dining group connection system connects groups, couples and/or individuals who are looking for intellectually stimulating or entertaining dining conversation with an “expert” in the field of their choice. The application allows experts/professionals to earn money as a registered host. Application as used herein may include a mobile application and/or website.

As used herein, the term “host,” “registered host,” and “expert” refers to an individual registered in the dining group interest connection system who has unique skills, knowledge and the like in a particular field or particular fields of interest. The term “guest,” and “dining guest” refers to an individual who joins the dining group interest connection system seeking an expert to host a meal and join the guest for a fee paid to the expert.

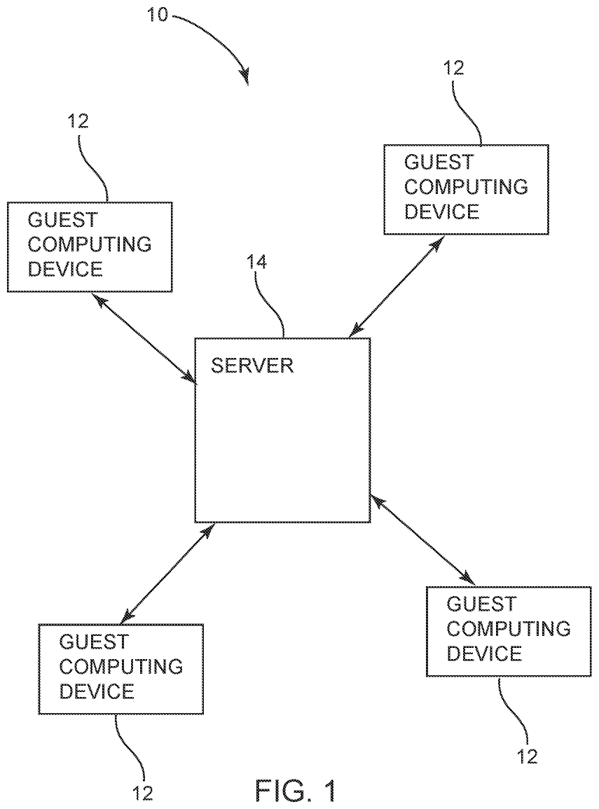

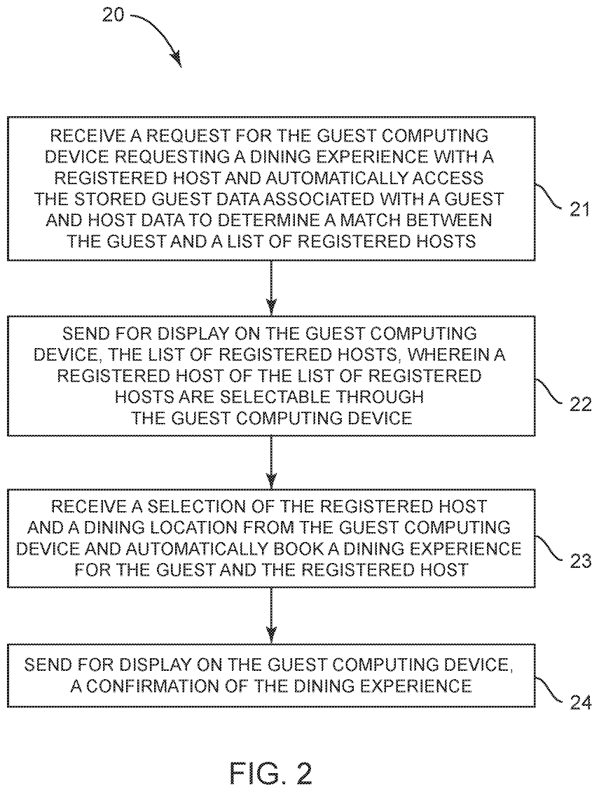

Referring to the drawings, FIG. 1 depicts an embodiment of a dining group interest connection system 10. The system 10 may include guest computing devices 12 and a computer server 14, wherein the guest computing devices 12 are coupled to the computer server 14. This coupling may be a network connection, such as through an Internet connection, wherein the guest computing devices 12 may communicate with and receive communication from the server 14.

This platform allows registered hosts (experts/professionals in their fields, individuals with unique experiences and the like) to be compensated outside of the regular work day, while sharing their knowledge, experience, opinions and so forth with guests who appreciate their unique skills, knowledge, experience and the like. The computer server 14 may include a memory storing guest data and storing host data. The memory of computer server 14 may store an application that supplies programming to the computer server 14, wherein execution of the application operates elements of the system 10. The application may allow guests to reserve a registered host and then to decide whether they want to have food delivered to their home or go out to a meal with the registered host. In the platform or system 10, the dining guest may place their food delivery order through a food delivery service and/or make a restaurant reservation for their meal with a food reservation company while at the same time reserving a registered host.

Utilizing the system 10, registered hosts (experts/professionals in their fields individuals with unique experiences and the like) may register and classify all areas of their expertise, knowledge, skills, experience, and the like, wherein the registered host information is stored in memory on the computer server 14. References may be required to validate the registered hosts is who he or she indicates and has the requisite expertise, knowledge, skills, experience, and the like as provided by the registered host during the registration process. This validation, in some embodiments may include a background check and the like. Through the system 10, the following may be available: registered hosts may set their availability, price, group size limit, and/or preapproved restaurant locations; location may be set by preauthorization with respect to restaurant and/or radius of travel distance; the dining guest may be required to prepay for the registered host; and the dining guest may also rate their host, post dining, through the application and/or add a gratuity.

With regard to the pricing or fee of utilizing the system 10, the pricing or fee for dining with a registered host may adjust in real time for certain registered hosts depending on the demand for those certain registered hosts. In some embodiments, the fee may be a price per person that will be dining with the registered host. In some embodiments, the fee may be some form of compensation and may or may not include the cost of the meal.

The dining guest has the capability to rate the registered host over various criteria, such as, but not limited to, the knowledge of the registered host within the area of interest that the registered host has indicated he or she is an expert in, the ability for conversation and the like. Additionally, the registered host may apply a rating to the dining guest that may allow a registered host to establish certain ratings as criteria for being selectable from a dining guest. As a registered host increases in rating, and further as the registered host is more popular based on the number of dining experiences and unique dining guests giving a rating, the system 10 may automatically adjust the price of dining with a registered host.

In embodiments, the group may be a one-on-one dining experience, a couple with the registered guest, a group with a registered host. Further, the registered host may be a single individual or may be a group of any certain number.

In a method 20 of using the dining group connection system, the computer server 14 through the application is programmed to perform the steps of method 20, wherein the dining guest logs on to the application operating on the server 14 via any guest computing device 12, including a mobile computing device, such as a smartphone or a laptop and/or tablet. The programmed method steps performed by the server 14 include receive a request for the guest computing device requesting a dining experience with a registered host and automatically access the stored guest data associated with a guest and host data to determine a match between the guest and a list of registered hosts (Step 21); send for display on the guest computing device, the list of registered hosts, wherein a registered host of the list of registered hosts are selectable through the guest computing device (Step 22); receive a selection of the registered host and a dining location from the guest computing device and automatically book a dining experience for the guest and the registered host (Step 23); and send for display on the guest computing device, a confirmation of the dining experience (Step 24). The list of hosts may also be geographic, such as by cities or states, and searches for registered hosts in that location. Selection of the registered host may be based on field of expertise. A registered host is selected and a dining time period (duration) may also be selected. A dining date, dining time, and/or dining location (restaurant and/or home with food delivery) may all be selected.

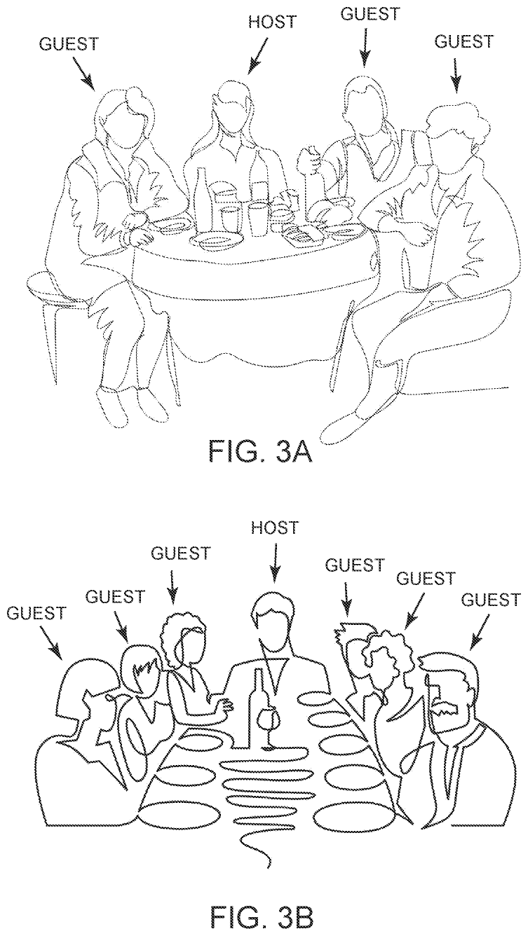

Referring further to FIGS. 3A and 3B, once the dining guest utilizes the system to establish a dining experience with a registered host, the venue may reserve a table for a particular time and a particular dining experience. The dining guest and the registered host may then dine together at the selected time a location in a selected dining experience, such as a private dining experience as depicted in FIG. 3A, wherein the guests are known before hand, or an open dining experience as depicted in FIG. 3B wherein the dining experience is open to any guest seeking to dine with the host. In an open dining experience, the number of open seats may be determined by the host. Payment to the registered host is handle separately from the dining experience.

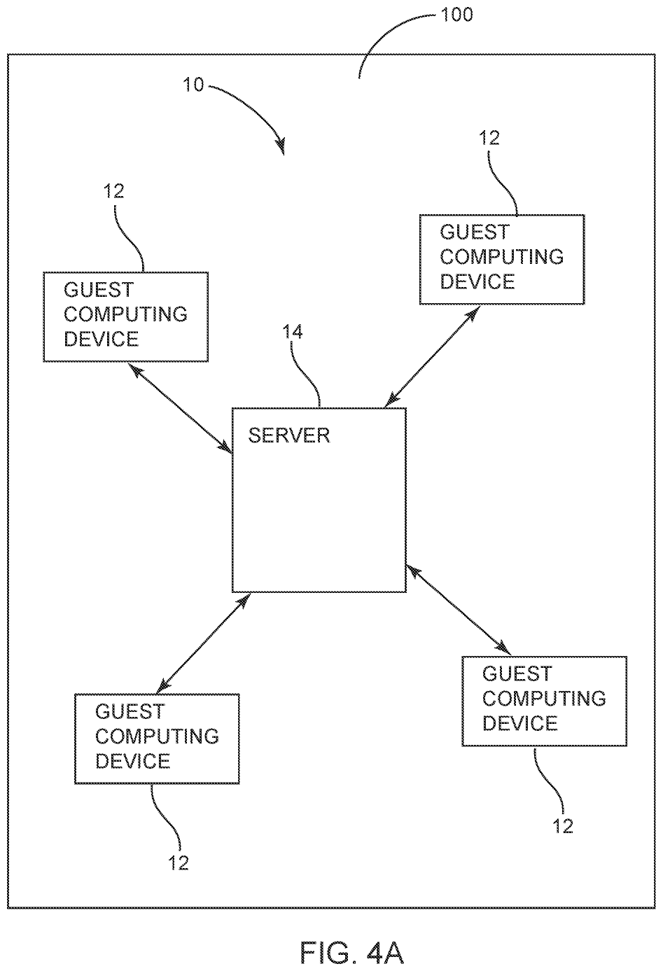

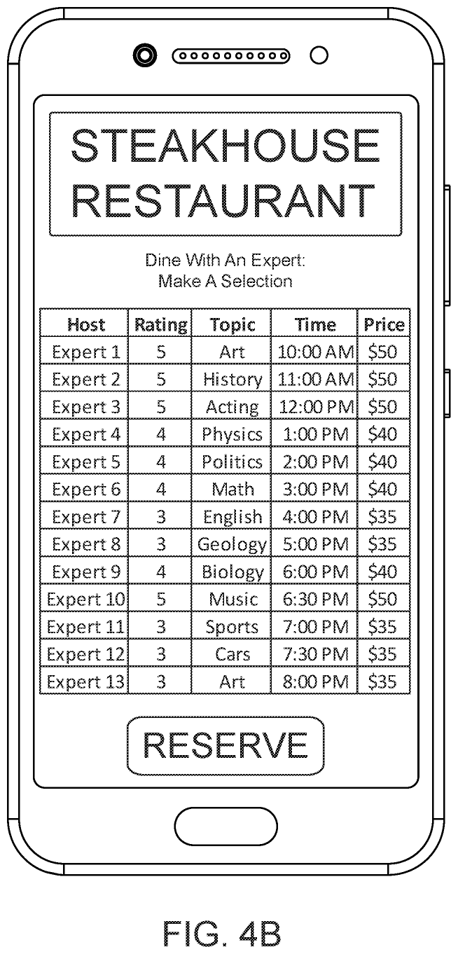

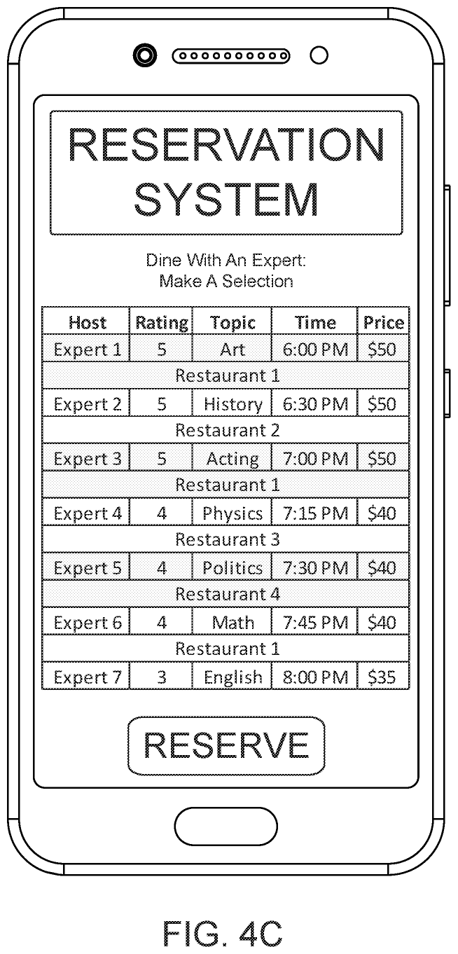

In some embodiments, as shown in FIGS. 4A-4C the system 10 may be utilized in certain types of ecosystems, such as a venue host environment 100, including a cruise ship, a restaurant or the like. In such venue host environments 100, the system 10 may operate as a hosting system to establish a table or tables within the environment for dining guest(s) and the registered host(s) for a specific time and meal. The system 10 may provide a list of registered hosts and the availability, any limits on the number in the dining party and other information accessible by a dining guest using a guest computing device 12 as shown in FIG. 4A. The dining guest may access the system 10 and the system 10 operates as described above, but within the particular environment.

The venue host environment 100 may further be a platform host environment wherein the system is operated by a restaurant reservation system. In such a platform host environment, as shown in FIG. 4C, the restaurant reservation system may provide a list of experts and various restaurants with available tables and registered hosts available for booking. The guest may utilize the restaurant reservation system to access the system 10 in order to reserve a table and an expert for a particular time at a particular restaurant or other venue.

Further still, the system may operate in a student ecosystem, wherein the student can seek a meal or an appointment with a registered host that is an expert within the field of study of the student and allow the student to glean information from the registered host about a particular topic to assist the student in his or her studies.

Additionally, the system 10 may be utilized in other environments, such as already established groups of people based on interest. This may include a hiking club, a book club, a dinner club, a tennis club, convention attendees and the like. The group may operate the system to select a registered host that has particular knowledge relating to the interests of the guests.

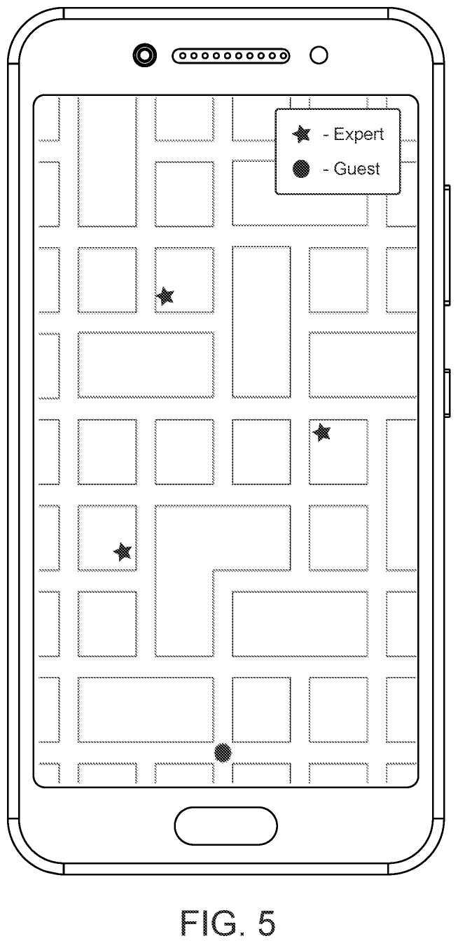

Referring to FIG. 5, the system 10 may include a proximity sensing module. The proximity sensing module may operate as part of a mobile application being executed on a mobile guest computing device 12. The expert may also be operating a mobile application on the expert's device, wherein the location of each may be broadcast. The guest may determine all experts within a predetermined proximity of the guest and available for a dining experience. Additionally, the proximity module can be utilized with a mapping feature to depict the location of the venue and in some embodiments to display directions to the location of the venue and if the guest or host is at the venue.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the guest's computer, partly on the guest's computer, as a stand-alone software package, partly on the guest's computer and partly on a remote computer or entirely on the remote computer or server. In the latter scenario, the remote computer may be connected to the guest's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above.

What is claimed is:

1. A dining group interest connection system comprising:
a server having a memory storing guest data, host data and an application that supplies programming to the server, wherein the server is accessible and operated by a restaurant reservation system to reserve a table;
a host computing device coupled to the server and
a guest computing device coupled to the server and operating a mobile application, wherein the server, through the stored application, is programmed to:
receive and store host data of registered hosts, wherein the host date comprises all areas of expertise, knowledge, skills, experience, and classifications of the same for each of the registered hosts;
validate the identity of each of the registered hosts and validate each of the registered hosts as the requisite expertise stored in the host data;
receive a field of interest from the guest computing device and store the field of interest as part of the guest data;
receive a request from the guest computing device requesting a dining experience with a registered host, the request including a location of the guest computing device as part of operating the mobile application, and automatically access the stored guest data associated with a guest and host data to determine a match between the guest and a list of registered hosts, wherein the match of the guest data and the host data comprises the host data including registered hosts having expertise in the field of interest stored in the guest data, and wherein the list of registered hosts comprises location information received by the server from registered hosts forming the list of registered hosts, wherein the list of registered hosts include registered hosts matching the guest data and within a predetermined proximity of the guest computing device;
send for display on the guest computing device, the list of registered hosts, wherein each registered host of the list of registered hosts is selectable through the guest computing device;
send for display on the guest computing device a map depicting the location of guest computing device and the list of registered hosts;
receive a selection of the registered host and a dining location from the guest computing device and automatically book a dining experience for the guest and the registered host; and
send for display on the guest computing device, a confirmation of the dining experience and directions on the map to the location of the registered host.

2. The system of claim 1, wherein the dining location is preapproved by the registered host.

3. The system of claim 1, wherein the dining guest selects dining duration.

4. The system of claim 1, wherein payment, dining date and/or dining time is preapproved by the registered host.

5. The system of claim 1, wherein the dining location is the dining guest's home.

6. The system of claim 1, wherein the dining location is the registered host's home.

7. The system of claim 1, wherein the dining location is a restaurant.

8. The system of claim 1, wherein the dining location is a cafeteria.
